(19) United States
(12) Patent Application Publication
(10) Pub. No.: US 2014/0173510 A1
(43) Pub. Date: Jun. 19, 2014

(54) INFORMATION PROCESSING APPARATUS, RECORDING MEDIUM, AND CONTROL METHOD

(71) Applicant: CANON KABUSHIKI KAISHA, Tokyo (JP)

(72) Inventor: Shoichi Kanno, Yokohama-shi (JP)

(73) Assignee: CANON KABUSHIKI KAISHA, Tokyo (JP)

(21) Appl. No.: 14/102,338

(22) Filed: Dec. 10, 2013

(30) Foreign Application Priority Data
Dec. 13, 2012 (JP) 2012-272335

(51) Int. Cl. G06F 3/0481

(52) U.S. Cl. CPC G06F 3/0481
USPC 715/808

(57) ABSTRACT

An information processing apparatus determines whether a medium contains specific information. If the medium is determined not to contain the specific information, the information processing apparatus displays a first window including information about the medium for a first time. If the medium is determined to contain the specific information, the information processing apparatus displays the first window for a second time longer than the first time.

### BACKGROUND

1. Field of the Disclosure

Aspects of the present invention generally relate to a technique for an information processing apparatus displaying a window.

2. Description of the Related Art

A function of controlling display of information about a medium is required of information processing apparatuses. Japanese Patent Application Laid-Open No. 2006-178966 discusses a technique for monitoring a user and optimizing accessibility options based on interactions with the user. Japanese Patent Application Laid-Open No. 2006-178966 further discusses a case of extending a display time of a notification “toast” as one of examples.

Assume an environment where a window including information about a medium is displayed for a certain period of time after the medium is inserted. The technique of Japanese Patent Application Laid-Open No. 2006-178966 does not discuss displaying a window including information about a medium for a certain period of time after insertion of the medium. With such a technique, a window including information about a medium may fail to be displayed for a certain period of time after the insertion of the medium.

Suppose that the medium contains a file that is highly needed to be installed on an information processing apparatus. Suppose also that a creator of the medium has thus created the medium so that the medium can be identified to have a high need for installation on an information processing apparatus. However, there has been a problem that conventional information processing apparatuses cannot distinguish between such a medium and other media, but process both media without distinction.

### SUMMARY

Aspects of the present invention relate to controlling the display time of a window including information about a medium, depending on whether the medium contains specific information.

According to an aspect of the present invention, an information processing apparatus includes a memory; and a processor in communication with the memory, the processor configured to control a determination unit configured to determine whether a medium contains specific information, and a display unit configured to, if the determination unit determines that the medium does not contain the specific information, display a window including information about the medium for a first time, and if the determination unit determines that the medium contains the specific information, display the window for a second time longer than the first time.

Further features and aspects of the present invention will become apparent from the following detailed description of exemplary embodiments with reference to the attached drawings.

### BRIEF DESCRIPTION OF THE DRAWINGS

FIG. 1 is a block diagram illustrating a configuration of a personal computer according to an exemplary embodiment.

FIG. 2 is a diagram illustrating an example of a screen displayed on a display device by an operating system (OS) running on the personal computer according to an exemplary embodiment.

FIG. 3A is a diagram illustrating an example of a screen where a display of a mounting notification message is added to the state of the screen of FIG. 2. FIG. 3B is an enlarged view of the mounting notification message displayed on the screen of FIG. 3A.

FIG. 4 is a flowchart illustrating extension condition determination processing about a display time of the mounting notification message according to a second exemplary embodiment.

FIG. 5A is a diagram illustrating a screen after a user responded to the mounting notification message displayed on the screen of FIG. 3A and the mounting notification message was switched to a processing selection menu. The screen illustrates an example where the medium contains an automatic execution program. FIG. 5B is an enlarged view of the processing selection menu displayed on the screen of FIG. 5A.

FIG. 6 is a flowchart illustrating a processing flow when a medium is mounted on the OS according to a third exemplary embodiment.

FIG. 7A is a diagram illustrating a screen after the user responded to the mounting notification message displayed on the screen of FIG. 3A and the mounting notification message was switched to a processing selection menu. The screen illustrates an example where the medium contains no automatic execution program. FIG. 7B is an enlarged view of the processing selection menu displayed on the screen of FIG. 7A.

FIG. 8 is a flowchart illustrating the extension condition determination processing about the display time of the mounting notification message according to the third exemplary embodiment.

FIG. 9A is a diagram illustrating a screen after the user responded to the mounting notification message displayed on the screen of FIG. 3A and the mounting notification message was switched to a processing selection menu. The screen illustrates an example where a medium such as a magneto-optical disk and a Universal Serial Bus (USB) memory in particular is mounted. FIG. 9B is an enlarged view of the processing selection menu displayed on the screen of FIG. 9A.

FIG. 10 is a block diagram illustrating a software configuration according to an exemplary embodiment.

FIG. 11 is a flowchart illustrating a processing flow when a medium is mounted on the OS.

FIG. 12 is a flowchart illustrating a processing flow when a medium is mounted on the OS according to the first exemplary embodiment and the second exemplary embodiment.

FIG. 13 is a flowchart illustrating the extension condition determination processing about the display time of the mounting notification message according to the first exemplary embodiment.

### DESCRIPTION OF THE EMBODIMENTS

Various exemplary embodiments, features, and aspects of the invention will be described in detail below with reference to the drawings.

Among typical OSs for controlling an information processing apparatus typified by a personal computer is Microsoft®) Windows®, which is widely prevalent.

In the Windows (registered trademark) series, when an optical drive medium is loaded into an optical drive or a general-purpose memory medium is attached to a USB port, a screen for selecting what processing to be performed appears according to the contents thereof. The screen continues being displayed until a user makes any response.

In the present specification, a specific OS is assumed for comparison. When an optical drive medium is loaded into an optical drive or a general-purpose memory medium is attached to a USB port, the specific OS initially displays a mounting notification message for a certain period of time. It is not until the user responds to the mounting notification message that the specific OS displays a screen for selecting what processing to be performed according to the contents thereof. The screen then continues being displayed until the user makes any response. Such processing has a problem that the mounting notification message will disappear unless the user responds to the mounting notification message displayed for the certain period of time.

Once the mounting notification message disappears, no screen will be displayed for selecting what processing to be performed according to the contents of the mounted medium. For users unfamiliar with the operation of a personal computer, it is easy to imagine that the behavior of being displayed for the certain period of time and disappearing unless responded results in the user failing to make any response.

In the foregoing description, the OS has been described in particular by using Windows® as an example. Aside from Windows®, the technique of the present specification may be applied to UNIX® based OSs, such as Linux®, which exhibit the behavior of displaying a mounting notification message to be described below for a certain period of time.

Manufacturers of printers, scanners, and other peripheral devices used in connection with information processing apparatuses such as a personal computer usually create software called drivers. Drivers control the peripheral devices so that the peripheral devices can be used by typical prevalent OSs. The drivers are often provided as stored in a medium and packaged with the peripheral devices.

The foregoing operation that the mounting notification message displayed for a certain period of time disappears unless the user responds to the mounting notification message causes the problem to customers of the peripheral devices that the drivers fail to be installed. This also causes the problem that the medium needs to be reloaded.

However, if the creator of a medium is unknown, it may be advantageous in terms of security that the mounting notification message displayed for a certain period of time disappears unless the user responds to the mounting notification message.

The reason is that if the medium contains any virus, the disappearance can delay access to the virus.

A personal computer as an exemplary embodiment of the information processing apparatus according to the present invention will be described.

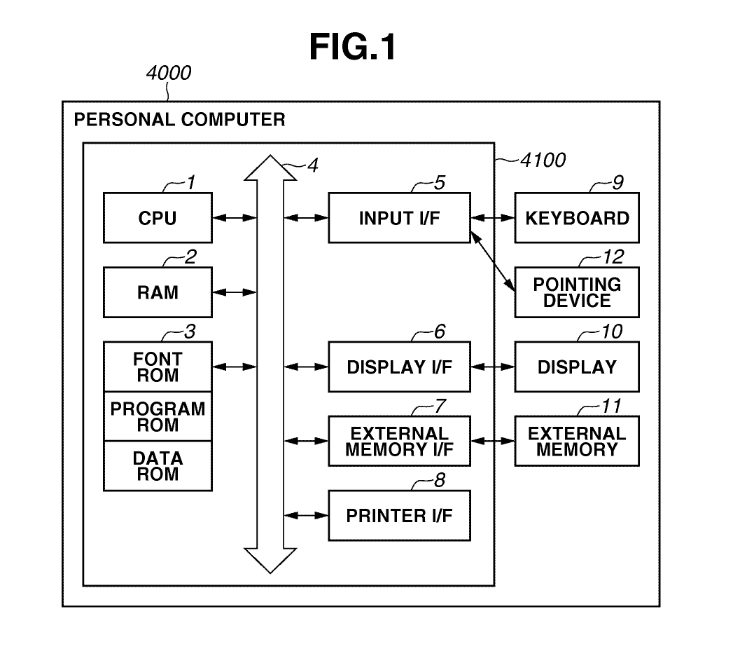

FIG. 1 is a block diagram illustrating a configuration of the personal computer according to the present exemplary embodiment.

In FIG. 1, a personal computer 4000 includes a central processing unit (CPU) 1. The CPU 1 performs document processing including graphics, images, characters, and/or tables (including spreadsheets) based on a document processing program stored in a program read-only memory (ROM) of a ROM 3 or an external memory 11. The CPU 1 further controls devices connected to a system bus 4 in a centralized manner.

The program ROM of the ROM 3 or the external memory 11 also stores an OS program (hereinafter, referred to as OS) serving as a control program of the CPU 1. A font ROM of the ROM 3 or the external memory 11 stores font data to be used in the document processing. A data ROM of the ROM 3 or the external memory 11 stores various types of data to be used when performing the document processing.

A random access memory (RAM) 2 functions as a main memory and a work area of the CPU 1. An input interface (I/F) 5 controls key inputs from a keyboard 9 and a pointing device 12. The pointing device 12 may be a mouse or a touch panel. A display I/F 6 controls display of a display 10. An external memory I/F 7 controls access to/from the external memory 11 which stores a boot program, various applications, font data, a user file(s), an edit file(s), and a printer driver. Examples of the external memory 11 include a hard disk (HD), a compact disc (CD), a digital versatile disc (DVD), and a USB memory.

A printer I/F 8 is connected to a not-illustrated multifunctional printing apparatus via a not-illustrated predetermined bidirectional interface (USB or Ethernet (registered trademark)). The printer I/F 8 performs communication control processing with the multifunctional printing apparatus. The CPU 1 performs rasterization processing for rasterizing outline fonts, for example, in a display information RAM which is configured on the RAM 2. The CPU 1 thereby enables a what-you-see-is-what-you-get (WYSIWYG) display on the display 10.

The CPU 1 opens various registered windows and performs various types of data processing based on commands designated by using a not-illustrated mouse cursor on the display 10.

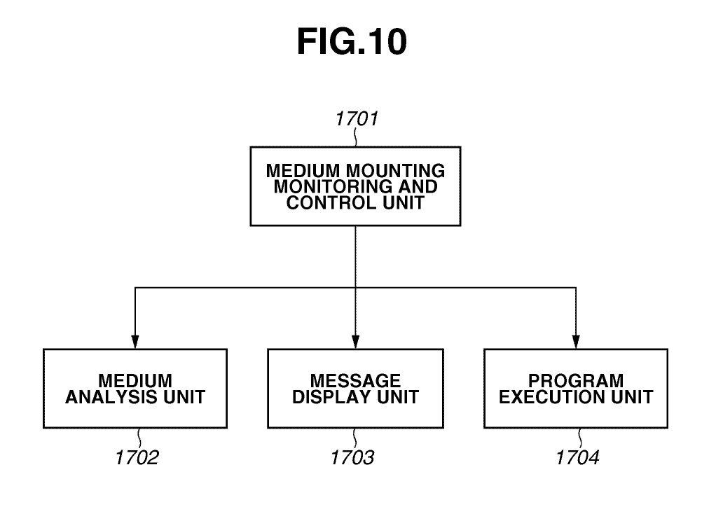

A software configuration will be described with reference to FIG. 10.

When an information medium such as an optical drive medium or a general-purpose memory medium is mounted on the information processing apparatus, a medium analysis unit 1702 analyzes information about the information medium. According to the analysis result, a medium mounting monitoring and control unit 1701 makes a determination. According to the determination, a message display unit 1703 displays an information medium mounting notification message for a time desired by the creator of the information medium. After the user responds to the information medium mounting notification message, a program execution unit 1704 performs processing according to processing on the information medium.

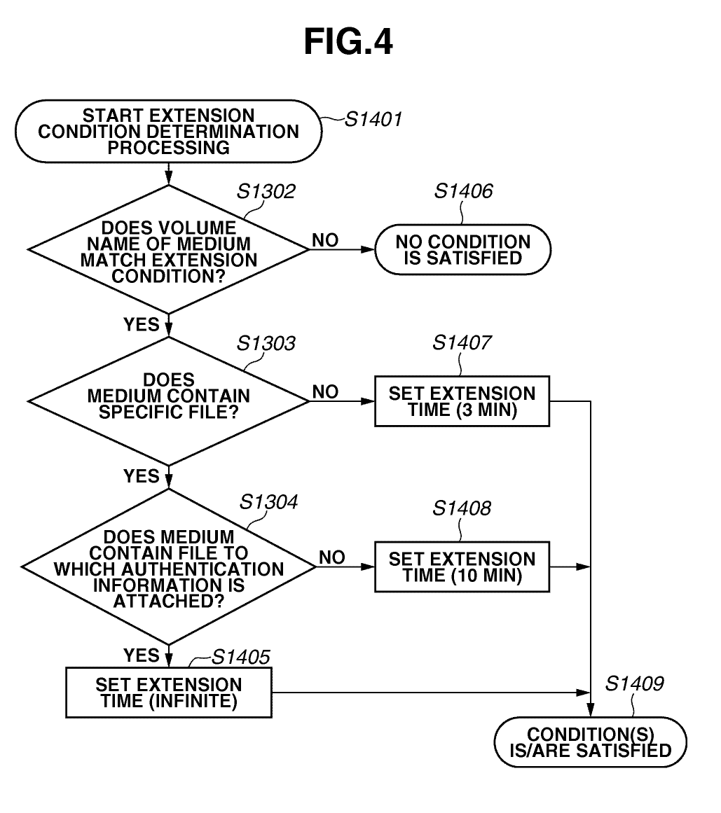

Processing described in the present specification with reference to the flowcharts of FIGS. 4, 6, 8, 11, 12, and 13 is implemented by the CPU 1 executing a program or programs recorded in the ROM 3 and/or the external memory 11.

### <Processing of Specific OS>

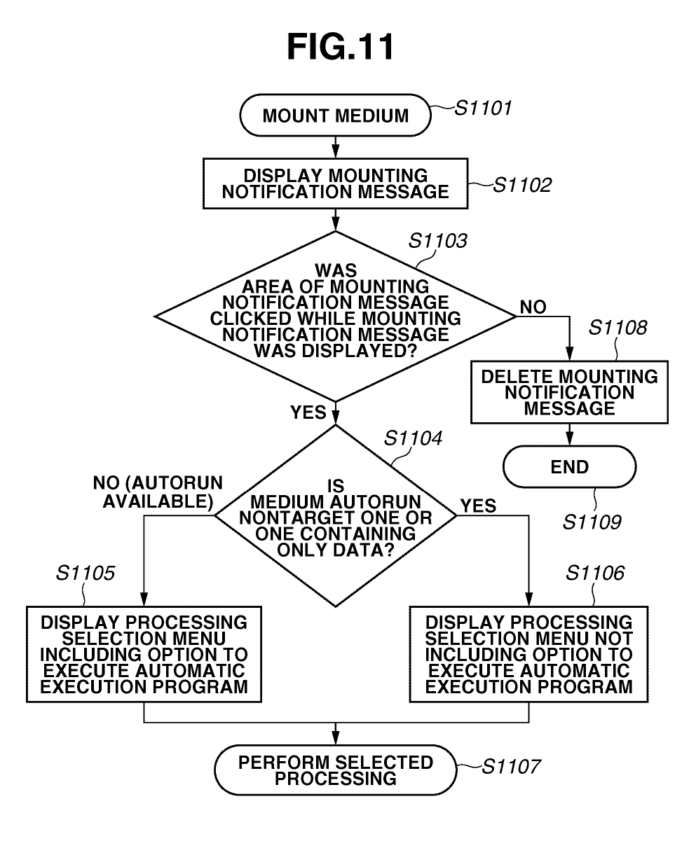

FIG. 11 is a flowchart illustrating a processing flow of the foregoing specific OS when a medium is mounted on the specific OS.

For the purpose of comparison with an exemplary embodiment of the present invention, the processing flow will initially be described.

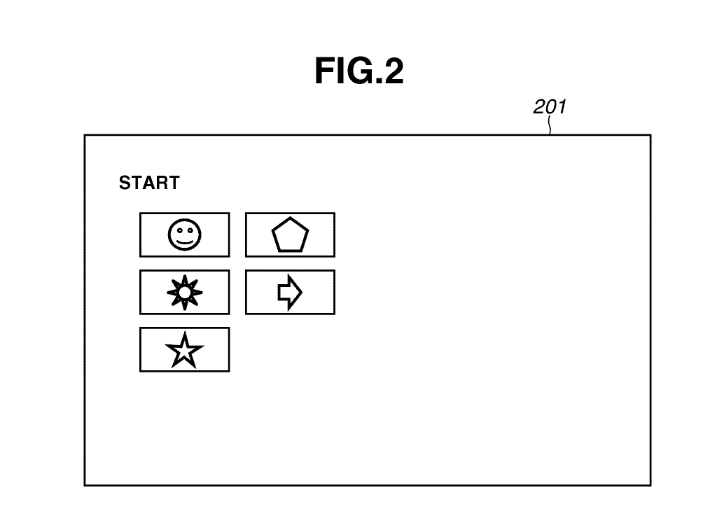

Before the user mounts the medium, a screen like the screen 201 illustrated in FIG. 2 is displayed on the display 10.

When the user mounts the medium as the external memory 11, then in step S1101 of FIG. 11, the specific OS starts processing.

In step S1102 of FIG. 11, the specific OS detects the mounting of the medium and displays the mounting notification message on the display 10.

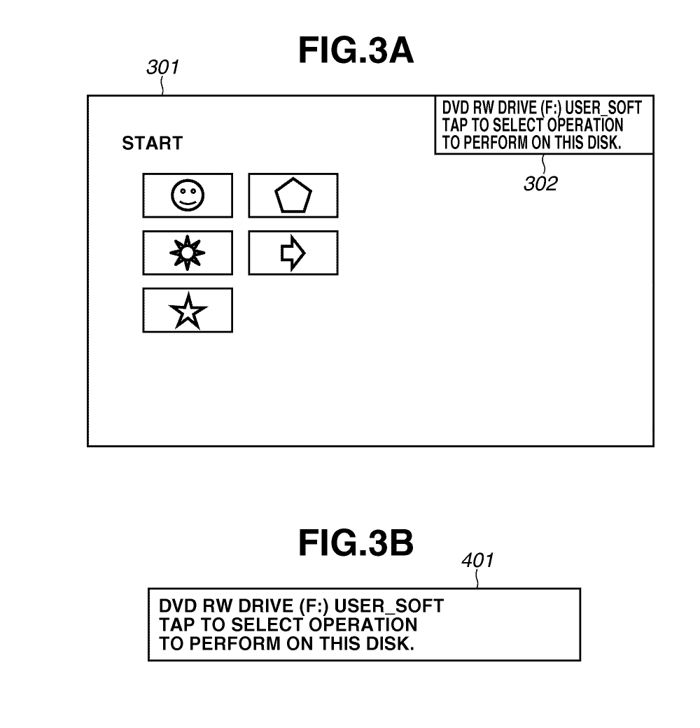

FIG. 3A illustrates display contents 301 of the display 10 where a mounting notification message 302 is displayed. FIG. 3B illustrates the mounting notification message 302 on a larger scale for better viewing, as a mounting notification message 401. The mounting notification message 302 (401) includes a drive name, a volume name, and a message for prompting the user's operation. It will be understood that the displayed drive name and volume name may vary with the environment of the personal computer 4000 and the medium.

The mounting notification message 302 and a processing selection menu to be described below are both windows overlaid on a background screen.

The mounting notification message 302 is displayed for a certain period of time determined by a setting of the specific OS in advance, such as five seconds. The mounting notification message 302 is then automatically deleted.

In step S1103 of FIG. 11, the specific OS determines whether an area of the mounting notification message 302 of FIG. 3A was clicked on the display 10 by the pointing device 12 while the mounting notification message 302 was displayed. If the area was clicked (YES in step S1103), the specific OS proceeds to step S1104. If the area was not clicked, i.e., was left unoperated (NO in step S1103), the specific OS proceeds to step S1108.

The behavior of a medium and an OS will be briefly described. While the following description deals with the behavior of a Windows (registered trademark) OS, the specific OS shall behave similarly.

A Windows (registered trademark) OS can usually locate a file named Autorun.inf on the highest hierarchical level of a medium. If Autorun.inf is located there and a program to be automatically executed (as employed herein, referred to as an automatic execution program) is specified in the Autorun.inf file, the OS displays an option to accept an instruction for the execution of the program (temporarily referred to as autorun execution). The user can select the displayed option for autorun execution.

The OS may be configured to automatically perform autorun execution instead of displaying the option to accept an instruction for autorun execution.

Depending on the type of the Windows (registered trademark) OS, there are defined autorun target media which are media (for example, CD and DVD) capable of autorun execution. There are also defined autorun non-target media which are media (for example, USB memory) incapable of autorun execution even in the presence of Autorun.inf.

Some types of Windows (registered trademark) OSs handle all media as autorun target media.

The following description of the present specification deals with a case where the OS makes a distinction between the former autorun target media and the latter autorun non-target media. However, an exemplary embodiment of the present invention is also applicable when the OS makes no such distinction.

In step S1104 of FIG. 11, the specific OS determines whether the medium is an autorun non-target medium or one containing only data.

If the medium is an autorun target medium and contains Autorun.inf and there is a program specified thereby (NO in step S1104), the specific OS proceeds to step S1105.

If the medium is an autorun non-target medium or one containing only data (YES in step S1104), the specific OS proceeds to step S1106.

If the specific OS does not distinguish between an autorun target medium and an autorun non-target medium as described above, then in step S1104, the specific OS only determines whether the medium is one containing only data, without determining whether the medium is an autorun non-target medium.

In step S1105 of FIG. 11, the specific OS deletes the mounting notification message 302 and displays a processing selection menu including an option to execute the automatic execution program instead.

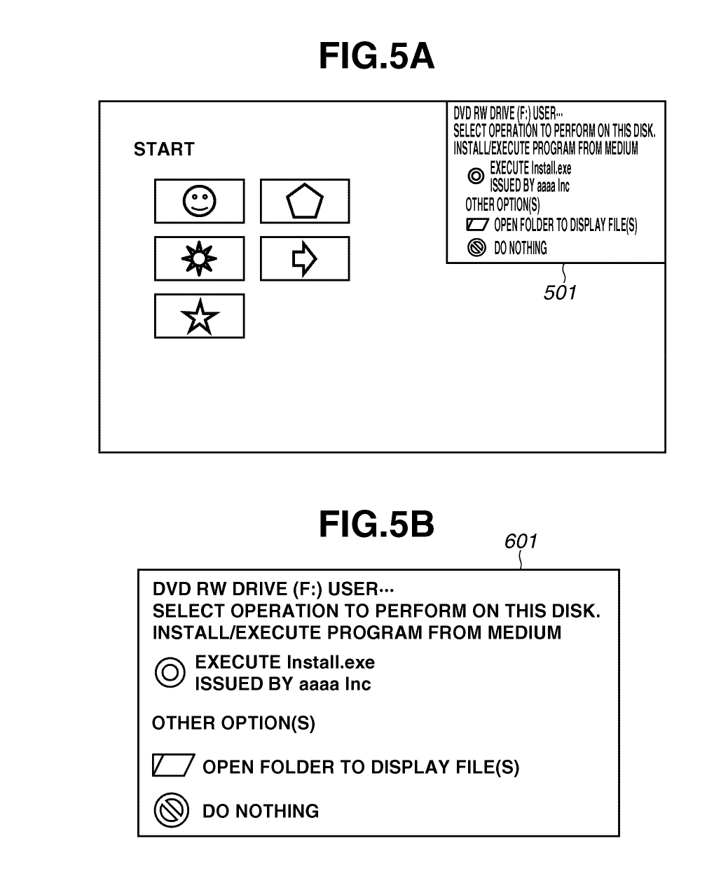

FIG. 5A illustrates display contents of the display 10 where a processing selection menu 501 including an option to execute an automatic execution program is displayed. FIG. 5B illustrates the processing selection menu 501 on a larger scale for better viewing, as the processing selection menu 601.

The processing selection menu 501 (601) includes a drive name, a volume name, and a message for prompting the user's operation like the mounting notification message 302. The drive name and the volume name displayed on the processing selection menu 501 (601) are the same as those displayed on the mounting notification message 302 that has triggered the display of the processing selection menu 501 (601).

In step S1106 of FIG. 11, the specific OS deletes the mounting notification message 302 and displays a processing selection menu not including an option to execute an automatic execution program instead.

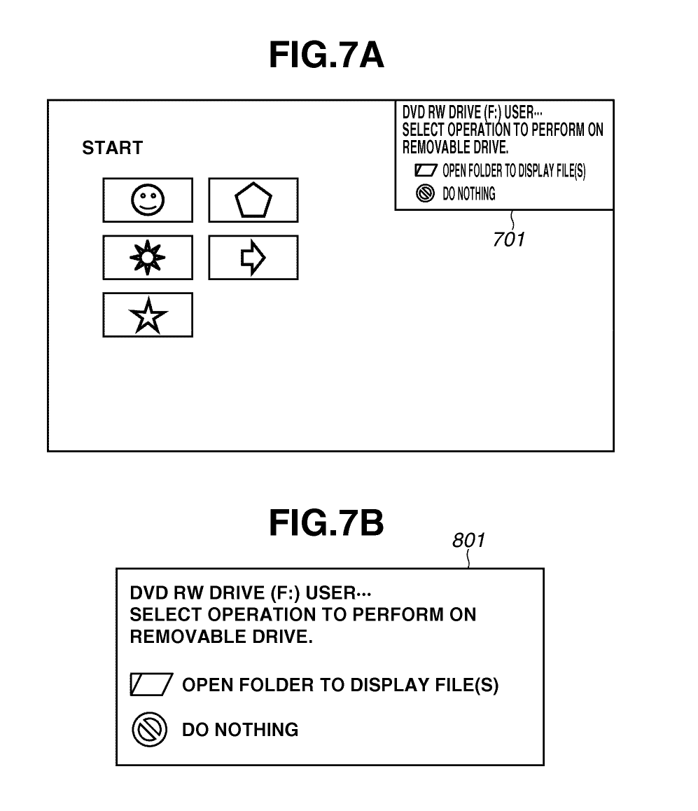

FIG. 7A illustrates display contents of the display 10 where a processing selection menu 701 not including an option to execute an automatic execution program is displayed. The processing selection menu 701 is displayed for a read-only medium such as CD or DVD. FIG. 7B illustrates the processing selection menu 701 on a larger scale for better viewing, as a processing selection menu 801.

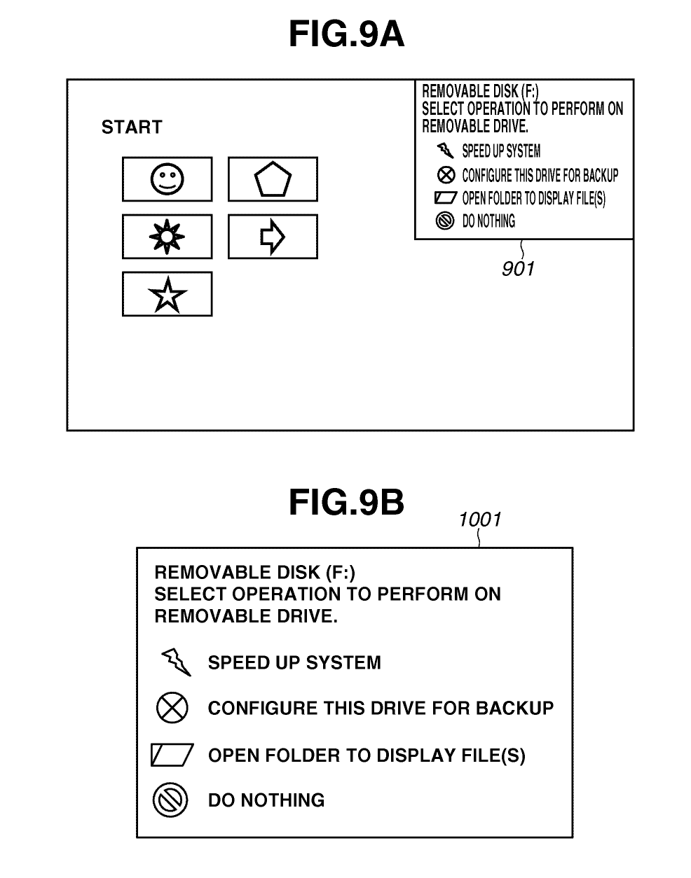

FIG. 9A illustrates display contents of the display 10 where a processing selection menu 901 not including an option to execute an automatic execution program is displayed. The processing selection menu 901 is displayed for a writable medium such as a magneto-optical disk or a USB memory. FIG. 9B illustrates the processing selection menu 901 on a larger scale for better viewing, as a processing selection menu 1001.

In step S1105 or S1106 of FIG. 11, the user selects processing, and the specific OS proceeds to step S1107. In step S1107, the specific OS performs the selected processing.

In step S1108 of FIG. 11, the specific OS simply deletes the mounting notification message 302. In other words, the specific OS restores the display contents of the display 10 from the state of the display contents 301 of FIG. 3 to the state of the screen 201 of FIG. 2.

The specific OS proceeds to step S1109 of FIG. 9 to end the processing.

The foregoing is the processing flow when a medium is mounted on the specific OS.

Specific processing of an OS obtained by improving the behavior of the foregoing specific OS will be described below. Hereinafter, the behavior-improved OS will be referred to simply as an OS.

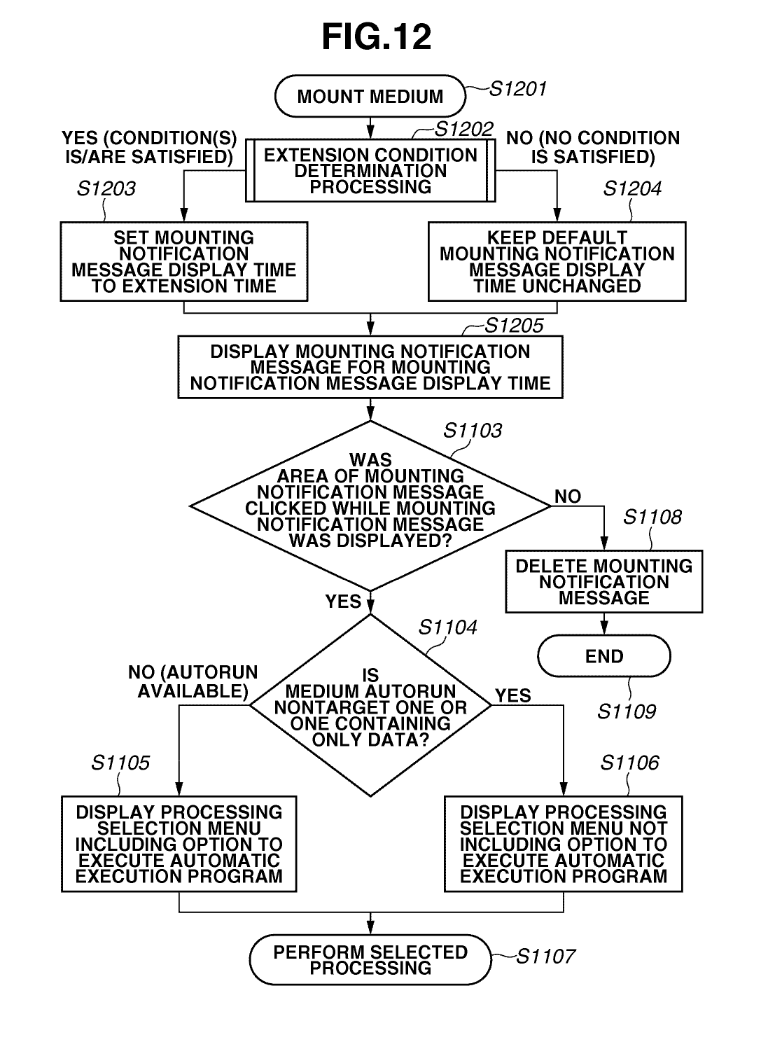

A processing flow of the OS when using a first exemplary embodiment of the present invention will be described with reference to FIG. 12.

Processing similar to that of the steps described above will be designated by the same numbers as those of the foregoing steps. A description thereof is omitted unless otherwise specified.

Before the user mounts a medium, the screen 201 of FIG. 2 is displayed on the display 10.

When the user mounts a medium as the external memory 11, then in step S1201 of FIG. 12, the OS starts processing.

In step S1202 of FIG. 12, the OS detects the mounting of the medium and performs extension condition determination processing.

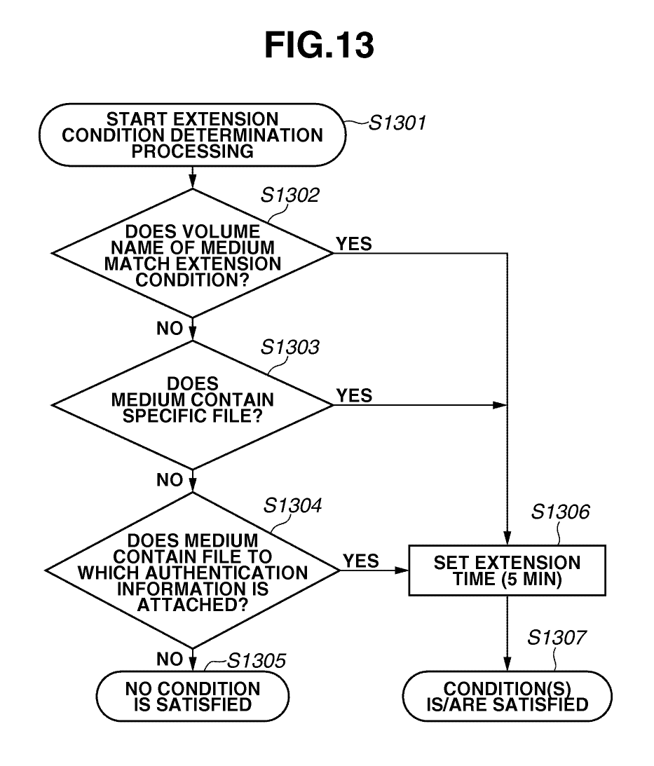

FIG. 13 illustrates an example of a flow for describing the extension condition determination processing of step S1202 in detail.

In step S1301 of FIG. 13, the OS starts the extension condition determination processing.

In steps S1302 to S1304, the OS determines whether the medium contains specific information.

In step S1302, the OS initially analyzes the volume name of the medium.

The OS determines whether the volume name matches an extension condition about a mounting notification message display time.

As an example of the extension condition, a meaning may be attached to a specific character such as “@”. If the volume name includes one or more of such a character, step S1302 results in yes. As another example, the OS may calculate a check sum of the volume name. If the calculation falls within a predetermined value range, step S1302 results in yes.

For example, the OS may calculate the check sum by converting the character string into hexadecimal numbers character by character and adding the hexadecimal numbers.

If step S1302 of FIG. 13 results in yes (YES in step S1302), the OS proceeds to step S1306. If no (NO in step S1302), the OS proceeds to step S1303.

In step S1303 of FIG. 13, the OS determines whether the medium contains a specific file.

As an example of the specific file, a specific meaning may be attached to a file named Extend.dat. If such a file is found in a predetermined specific directory location of the medium, step S1303 results in yes.

The foregoing file name is just an example. The specific file is not limited to such a file name.

If step S1303 of FIG. 13 results in yes (YES in step S1303), the OS proceeds to step S1306. If no (NO in step S1303), the OS proceeds to step S1304.

In step S1304 of FIG. 13, the OS determines whether the medium contains a file to which authentication information is attached.

For example, if a program file to be automatically executed is specified in the file named Autorun.inf and the creator has attached an electronic signature to the program file to be automatically executed, step S1304 results in yes.

For example, if there is no program file to be automatically executed, the creator may prepare a dummy program file of executable format having the same name as the volume name of the medium and attach an electronic signature to the dummy program file. In such a case, step S1304 results in yes.

To prevent falsification of the program file to be automatically executed as well, a message digest 5 (MD5) hash of the program file to be automatically executed may be calculated. Then, the creator may prepare a dummy file of executable format having the calculated hash value as its file name and attach an electronic signature to the dummy file. In such a case, step S1304 may result in yes.

The creator may provide a program to be automatically executed to an OS vendor, and have the OS vendor generates and sends back an authentication file based on the program. Such authentication file and the program to be automatically executed may be stored in the same location.

If step S1304 of FIG. 13 results in yes (YES in step S1304), the OS proceeds to step S1306. If no (NO in step S1304), the OS proceeds to step S1305.

In step S1305 of FIG. 13, the OS ends the extension condition determination processing with the result that no condition is satisfied.

In step S1306 of FIG. 13, the OS sets five minutes as an example of the extension time. The OS then proceeds to step S1307.

In step S1307 of FIG. 13, the OS ends the extension condition determination processing with the result that a condition is satisfied.

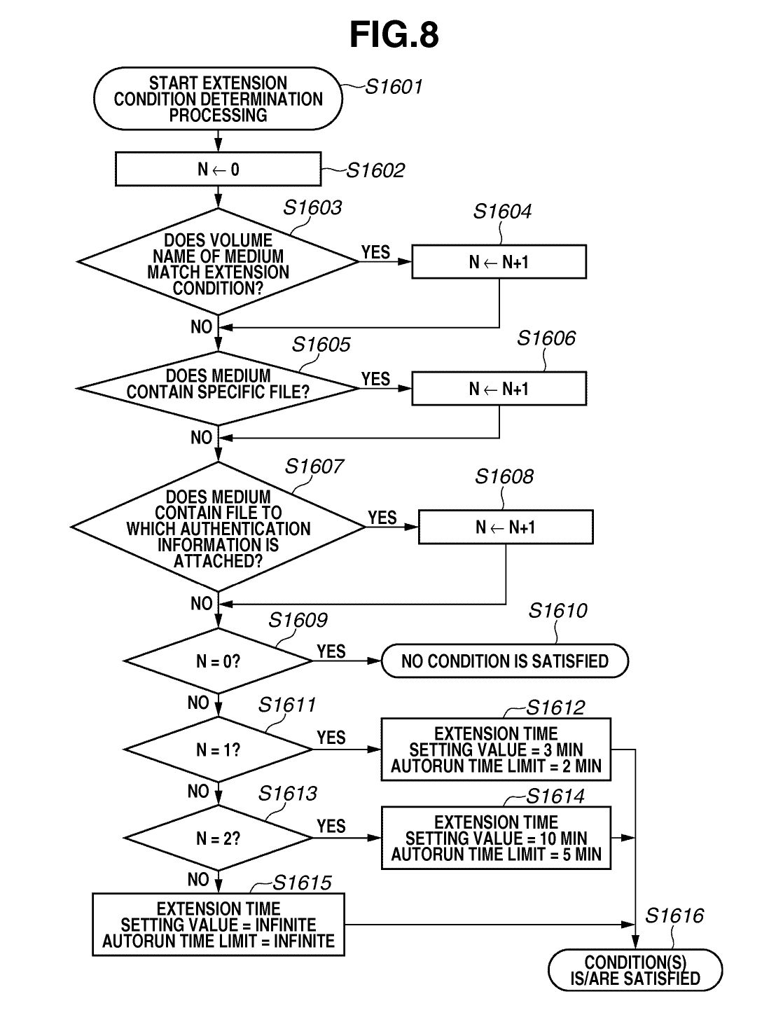

The purpose of the processing of FIG. 13 is to extend the display time of the mounting notification message 302. The processing of FIG. 13 may be configured so that, at the beginning of the processing, the OS determines whether the extension time to be set in step S1306 is longer than the OS's default display time of the mounting notification message 302. If the extension time to be set in step S1306 is shorter than the default display time, then in step S1305, the OS ends the processing of FIG. 13, determining that no condition is satisfied. Such a configuration may also be used for the processing of FIGS. 4 and 8 to be described below.

In the example of FIG. 13, the OS makes the three determinations in steps S1302, S1303, and S1304 in succession. However, the OS need not make all the three determinations in succession, and may make any one or two of the determinations. More than three conditions may be provided.

In step S1202 of FIG. 12, if the extension condition determination processing ends with the result that a condition is satisfied (YES in step S1202), the OS proceeds to step S1203. If the extension condition determination processing ends with the result that no condition is satisfied (NO in step S1202), the OS proceeds to step S1204.

In step S1203 of FIG. 12, the OS sets the mounting notification message display time to the value of the extension time determined by the extension condition determination processing of step S1202. The OS proceeds to step S1205 of FIG. 12.

In step S1204 of FIG. 12, the OS keeps the predetermined default mounting notification message display time unchanged. The OS proceeds to step S1205 of FIG. 12.

In step S1205 of FIG. 12, the OS displays a mounting notification message like the mounting notification message 302 of FIG. 3A on the display 10 for the mounting notification message display time. After a lapse of the mounting notification message display time, the OS automatically deletes the mounting notification message. The OS then proceeds to step S1103.

The processing of step S1103 and subsequent steps is the same as in FIG. 11. A description thereof will be omitted.

The foregoing is the processing flow when a medium is mounted on the OS according to the first exemplary embodiment of the present invention.

As described above, an exemplary embodiment of the present invention can be used to change the display time of the mounting notification message according to the volume name attached to the medium. The display time of the mounting notification message can also be changed based on a predetermined file contained in the medium. The display time of the mounting notification message can also be changed based on an authentication information file contained in the medium. The display time of the mounting notification message can also be changed based on multiple conditions including the volume name attached to the medium, a predetermined file contained in the medium, and an authentication information file contained in the medium.

The present second exemplary embodiment deals with an example where the OS changes the extension time depending on whether the medium satisfies severer conditions than those determined in the first exemplary embodiment.

FIG. 4 illustrates a flow of extension condition determination processing of step S1202 different from that of the first exemplary embodiment.

Processing similar to that of the steps described above will be designated by the same numbers as those of the foregoing steps. A description thereof is omitted unless otherwise specified.

In step S1401 of FIG. 4, the OS starts the extension condition determination processing.

If step S1302 of FIG. 4 results in yes (YES in step S1302), the OS proceeds to step S1303. If no (NO in step S1302), the OS proceeds to step S1406.

If step S1303 of FIG. 4 results in yes (YES in step S1303), the OS proceeds to step S1304. If no (NO in step S1303), the OS proceeds to step S1407.

If step S1304 of FIG. 4 results in yes (YES in step S1304), the OS proceeds to step S1405. If no (NO in step S1303), the OS proceeds to step S1408.

In step S1405 of FIG. 4, the OS sets an infinite time limit as an example of the extension time because the extension condition determination processing results in that all the prepared conditions are satisfied. The OS then proceeds to step S1409 of FIG. 4.

In the second exemplary embodiment, the OS makes comparisons about the three prepared conditions in order. To obtain a longer extension time, as many conditions as possible need to be satisfied.

The OS proceeds to step S1406 of FIG. 4 if no condition is satisfied. In step S1406, the OS ends the extension condition determination processing with the result that no condition is satisfied.

In step S1407 of FIG. 4, the OS sets three minutes as an example of the extension time because the extension condition determination processing results in that only one condition is satisfied. The OS proceeds to step S1409 of FIG. 4.

In step S1408 of FIG. 4, the OS sets ten minutes as an example of the extension time because the extension condition determination processing results in that only two conditions are satisfied. The OS proceeds to step S1409 of FIG. 4.

In step S1409 of FIG. 4, the OS ends the extension condition determination processing with the result that a condition or conditions is/are satisfied.

After the end of the processing of FIG. 4, the OS executes the same processing as in FIG. 12.

In the example of FIG. 4, the OS makes the three determinations in steps S1302, S1303, and S1304 in succession. However, the OS needs not make all the three determinations in succession. It may make any one or two of the determinations. More than three conditions may be provided.

In such a manner, the OS can extend the display time of the mounting notification message 302 as the medium satisfies severer conditions.

The present third exemplary embodiment deals with a method for setting a longer extension time as the medium satisfies more of the conditions determined in the first exemplary embodiment. In addition to changing the display time of the mounting notification message 302, the OS also controls the display of the processing selection menu. Specifically, the OS switches whether to display a processing selection menu including an option to execute an automatic execution program or display a processing selection menu not including an option to execute an automatic execution program, according to elapsed time since the display of the mounting notification message 302. In other words, the OS switches the processing selection menus to be displayed depending on whether a certain period of time has elapsed.

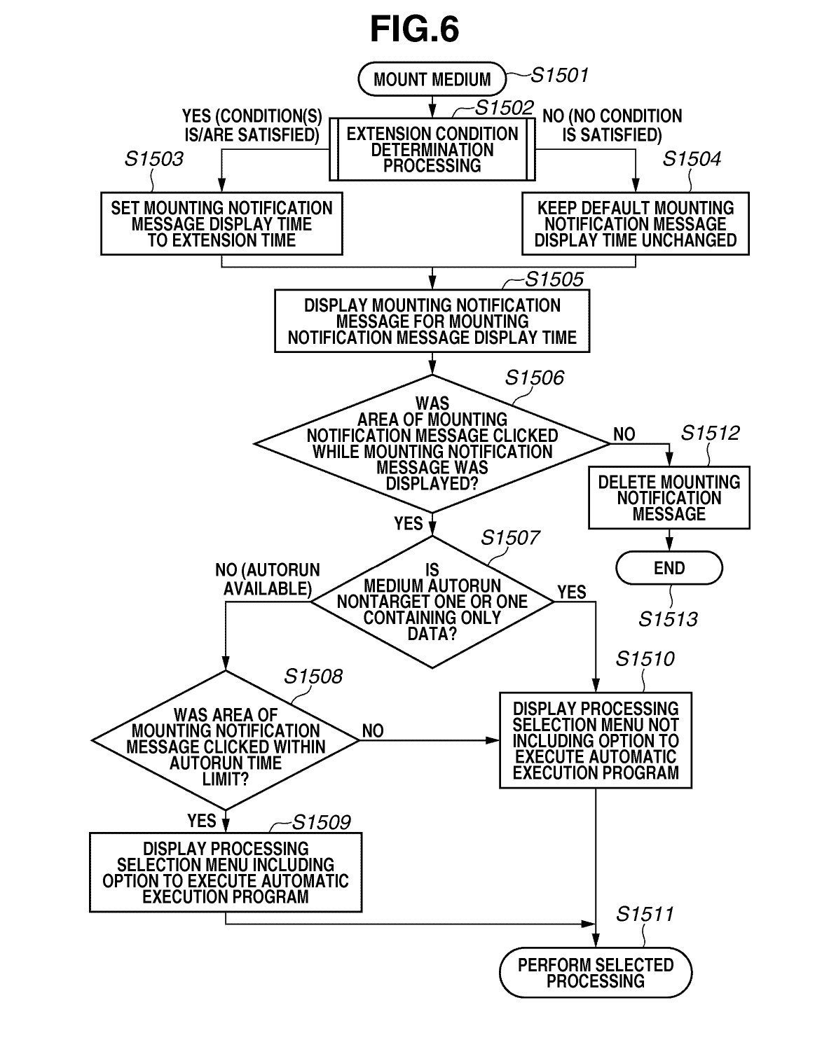

A processing flow of the OS according to the third exemplary embodiment of the present invention will be described with reference to FIG. 6.

Processing similar to that of the steps described above will be designated by the same numbers as those of the foregoing steps. A description thereof is omitted unless otherwise specified.

Before the user mounts a medium, a screen like the screen 201 illustrated in FIG. 2 is displayed on the display 10.

When the user mounts a medium as the external memory 11, then in step S1501 of FIG. 6, the OS starts processing.

In step S1502 of FIG. 6, the OS performs extension condition determination processing.

FIG. 8 illustrates an example of a flow for describing the extension condition determination processing of step S1502 in detail.

In step S1601 of FIG. 8, the OS starts the extension condition determination processing.

In step S1602 of FIG. 8, the OS first initializes a variable N to 0. The variable N is intended to count the number of conditions matching the extension conditions of the extension condition determination processing.

If step S1603 of FIG. 8 results in yes (YES in step S1603), the OS proceeds to step S1604. If no (NO in step S1603), the OS proceeds to step S1605.

In step S1604 of FIG. 8, the OS adds 1 to the variable N. The OS proceeds to step S1605.

If step S1605 of FIG. 8 results in yes (YES in step S1605), the OS proceeds to step S1606. If no (NO in step S1607), the OS proceeds to step S1607.

In step S1606 of FIG. 8, the OS adds 1 to the variable N. The OS proceeds to step S1607.

If step S1607 of FIG. 8 results in yes (YES in step S1607), the OS proceeds to step S1608. If no (NO in step S1607), the OS proceeds to step S1609.

In step S1608 of FIG. 8, the OS adds 1 to the variable N. The OS proceeds to step S1609.

In step S1609 of FIG. 8, the OS determines whether the variable N is 0. If the variable N is 0 (YES in step S1609), the OS proceeds to step S1610. If not (NO in step S1609), the OS proceeds to step S1611.

In step S1610 of FIG. 8, the OS ends the extension condition determination processing with the result that no condition is satisfied.

In step S1611 of FIG. 8, the OS determines whether the variable N is 1. If the variable N is 1 (YES in step S1611), the OS proceeds to step S1612. If not (NO in step S1611), the OS proceeds to step S1613.

In step S1612 of FIG. 8, the OS sets an extension time setting value to three minutes and an autorun time limit to two minutes because the extension condition determination processing results in that only one condition is satisfied. The three minutes and two minutes are just an example, and the extension time setting value and the autorun time limit are not limited to such values. The OS proceeds to step S1616.

In step S1613, the OS determines whether the variable N is 2. If the variable N is 2 (YES in step S1613), the OS proceeds to step S1614. If not (NO in step S1613), the OS proceeds to step S1615.

In step S1614 of FIG. 8, the OS sets the extension time setting value to ten minutes and the autorun time limit to five minutes because the extension condition determination processing results in that only two conditions are satisfied. The ten minutes and five minutes are just an example, and the extension time setting value and the autorun time limit are not limited to such values. The OS proceeds to step S1616.

In step S1615 of FIG. 8, the OS sets the extension time setting value to infinite minutes and the autorun time limit to infinite minutes because the extension condition determination processing results in that all the three conditions are satisfied. The infinite minutes are just an example, and the extension time setting value and the autorun time limit are not limited to such values. The OS proceeds to step S1616.

In step S1616 of FIG. 8, the OS ends the extension condition determination processing with the result that a condition or conditions is/are satisfied.

In the example of FIG. 8, the OS makes the three determinations in steps S1603, S1605, and S1607 in succession. The OS needs not make all the three determinations in succession, and may make any one or two of the determinations. The OS may perform the extension condition determination processing with more than three conditions.

Returning to the processing of FIG. 6, the following description deals with step S1508 which is a difference from the processing of FIG. 12. In addition, processes performed in steps S1505 and S1506 are the same as those in steps S1205 and S1103.

If step S1507 of FIG. 6 results in no (NO in step S1507), the OS proceeds to step S1508.

In step S1508 of FIG. 6, the OS determines whether the area of the mounting notification message 302 was clicked within the autorun time limit determined by the extension condition determination processing of step S1502. If the area was clicked within the autorun time limit (YES in step S1508), the OS proceeds to step S1509. If not (NO in step S1508), the OS proceeds to step S1510.

The foregoing is the processing flow when a medium is mounted on the OS according to the present exemplary embodiment.

In the present exemplary embodiment, the OS ignores an automatic execution program, if any, contained in the medium if the user makes a response within the display time of the mounting notification message 302 but not within a response time limit. The OS can thus display a processing selection menu not including an option to execute the automatic execution program.

The effect of ignoring the automatic execution program contained in the medium if the user makes a response within the display time of the mounting notification message 302 but not within the response time limit will be described.

For example, suppose that there are two persons including one (A) who is positively wanted to execute an autorun program and one (B) who is least wanted to execute the autorun program. Suppose also that A knows that the autorun program can be executed by responding to the mounting notification message 302 within a response time limit, and B does not. In such a situation, the configuration of the present exemplary embodiment can be used to provide an environment in which A is likely to execute the autorun program and B is less likely to execute the autorun program.

An exemplary embodiment of the present invention may be implemented by performing the following processing.

The processing includes providing software (program) configured to implement the functions of the foregoing exemplary embodiments to a system or an apparatus via a network or various storage media, and reading and executing the program by a computer (or CPU or micro processing unit (MPU)) of the system or the apparatus.

According to an exemplary embodiment of the present invention, the display time of a window including information about a medium can be controlled depending on whether the medium contains specific information.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and function.

This application claims the benefit of Japanese Patent Application No. 2012-272335 filed Dec. 13, 2012, which is hereby incorporated by reference herein in its entirety.

What is claimed is:

1. An information processing apparatus comprising:
a memory; and
a processor in communication with the memory, the processor configured to control: a determination unit configured to determine whether a medium contains specific information; and
a display unit configured to, if the determination unit determines that the medium does not contain the specific information, display a window including information about the medium for a first time, and if the determination unit determines that the medium contains the specific information, display the window for a second time longer than the first time.

2. The information processing apparatus according to claim 1, wherein the specific information is a specific character in a volume name of the medium.

3. The information processing apparatus according to claim 1, wherein the specific information is a specific file in the medium.

4. The information processing apparatus according to claim 1, wherein the specific information is a specific file in the medium, an electronic signature being attached to the specific file.

5. The information processing apparatus according to claim 1, wherein the processor is further configured to control:
a setting unit configured to set the second time according to how many of first to third conditions are satisfied, the first condition being that the medium has a specific volume name, the second condition being that the medium contains a specific file, and the third condition being that the medium contains a specific file to which an electronic signature is attached.

6. The information processing apparatus according to claim 1, wherein the processor is further configured to control:
a second display unit configured to display a second window for accepting an operation about a file of the medium from a user, the second window being displayed when the window is designated by the user.

7. The information processing apparatus according to claim 6, wherein the processor is further configured to control:
a second determination unit configured to determine time elapsed since the window was displayed,
wherein the second display unit is configured to, if the second determination unit determines that a certain period of time has not elapsed since the window was displayed, display the second window including an option to execute an automatic execution program, and if the second determination unit determines that the certain period of time has elapsed since the window was displayed, display the second window not including the option to execute the automatic execution program.

8. A non-transitory recording medium storing a program for causing a computer to function as:
a determination unit configured to determine whether a medium contains specific information; and
a display unit configured to, if the determination unit determines that the medium does not contain the specific information, display a window including information about the medium for a first time, and if the determination unit determines that the medium contains the specific information, display the window for a second time longer than the first time.

9. The recording medium according to claim 8, wherein the specific information is a specific character in a volume name of the medium.

10. The recording medium according to claim 8, wherein the specific information is a specific file in the medium.

11. The recording medium according to claim 8, wherein the specific information is a specific file in the medium, an electronic signature being attached to the specific file.

12. The recording medium according to claim 8, wherein the computer is caused to further function as a setting unit configured to set the second time according to how many of first to third conditions are satisfied, the first condition being that the medium has a specific volume name, the second condition being that the medium contains a specific file, and the third condition being that the medium contains a specific file to which an electronic signature is attached.

13. The recording medium according to claim 8, wherein the computer is caused to further function as a second display unit configured to display a second window for accepting an operation about a file of the medium from a user, the second window being displayed when the window is designated by the user.

14. The recording medium according to claim 13, wherein the computer is caused to further function as a second determination unit configured to determine time elapsed since the window was displayed, and
wherein the second determination unit is configured to, if the second determination unit determines that a certain period of time has not elapsed since the window was displayed, display the second window including an option to execute an automatic execution recording medium, and if the second determination unit determines that the certain period of time has elapsed since the window was displayed, display the second window not including the option to execute the automatic execution recording medium.

15. A control method comprising:
determining whether a medium contains specific information; and
if the medium is determined not to contain the specific information, displaying a window including information about the medium for a first time, and if the medium is determined to contain the specific information, displaying the window for a second time longer than the first time.

16. The control method according to claim 15, wherein the specific information is a specific character in a volume name of the medium.

17. The control method according to claim 15, wherein the specific information is a specific file in the medium.

18. The control method according to claim 15, wherein the specific information is a specific file in the medium, an electronic signature being attached to the specific file.

19. The control method according to claim 15, further comprising setting the second time according to how many of first to third conditions are satisfied, the first condition being that the medium has a specific volume name, the second condition being that the medium contains a specific file, and the third condition being that the medium contains a specific file to which an electronic signature is attached.

20. The control method according to claim 15, further comprising displaying a second window for accepting an operation about a file of the medium from a user, the second window being displayed if the window is designated by the user.
